(19) United States
(12) Patent Application Publication
(10) Pub. No.: US 2015/0075348 A1
(43) Pub. Date: Mar. 19, 2015

(54) SELF ALIGNING FOOD PUSHER FOR MANDOLIN TYPE SLICERS

(71) Applicant: LIFETIME BRANDS, INC., Garden City, NY (US)

(72) Inventor: Jasper E. Wheeler, Brooklyn, NY (US)

(73) Assignee: LIFETIME BRANDS, INC., Garden City, NY (US)

(21) Appl. No.: 14/026,002

(22) Filed: Sep. 13, 2013

(51) Int. Cl. B26D 3/28; B26D 7/01

(52) U.S. Cl. CPC B26D 3/283; B26D 7/01; B26D 2003/287
USPC 83/707

(57) ABSTRACT

A food slicing system having a mandolin slicer with side walls and a food pusher configured for use with the same. The food pusher is designed to have a self-aligning function when used with the slicer. The food grip portion of the food pusher includes multiple surfaces configured to allow the pusher to self-align between the walls of the slicer during use while also maintain constant and fixed contact with the food product being sliced.

### BACKGROUND

1. Technical Field

The present principles relate to food slicing devices. More particularly, it relates a food pusher for use with mandolin type food slicers.

2. Related Art

Food slicers, namely mandolin slicers are commonly used in food preparation applications. Mandolin slicers can be used to cut a variety of different food products of various shapes. However such slicers often create safety hazards when one uses the slicer by holding the food item in their hand, thus subjecting their finger tips to exposure to the cutting blade as the food product is continually sliced down to the cutting or sliding surface of the mandolin slicer.

Food pushing devices for mandolin slicers have been implemented in an effort to prevent a user from directly contacting the food product being sliced, and thereby increase the safety in use of the same. However, known food pushers have their own drawbacks. More specifically, various food pushing devices are made with specific shaped food items in mind. For example, most food pushing devices are designed for use with a substantially spherical food item (e.g., apple, pear, tomato, etc.). As such, these food pusher devices do not work well with food products that have a more cylindrical or elongated irregular shape (e.g., carrots, zucchini, cucumbers, etc.)

Most importantly, current food pushers do not “self-align” with the cutting bed and as a result, not only will the food item be cut incorrectly, a risk of losing the food item in the slicer or dislodging the same from the slicer exists.

### SUMMARY

According to an implementation, the food pusher with corresponding mandolin slicer of the present principles overcomes the drawbacks of prior art slicers and pushers and can be used with almost any size or shape food item.

According to an implementation, the food slicing system includes a mandolin slicer having a two upwardly extending opposing side walls and a slicing bed positioned between the side walls, and a food pusher having a circular food grip portion on an underside thereof and being configured to self-align within the walls of the slicer during use.

The food pusher includes an upper portion configured to be held by a user and a lower food engaging portion. The lower food engaging portion generally includes a food grip having a plurality of food grip teeth arranged on an underside thereof in a circular manner. A shaft is slidably engaged by the part of the upper portion and has a lower food engaging surface positioned within the circular plurality of food grip teeth. A plurality of fixed rods positioned within the circular plurality of food grip teeth. The food engaging surface has a plurality of holes corresponding to the plurality of fixed rods such that said shaft slides freely over said fixed rods.

The upper portion includes a body having a lower end configured to be secured to the food grip, and a knob positioned at the top of the body and connected to the slidable shaft. The knob enables retraction and extension of the food engaging surface of the shaft. When the knob is retracted, a food hopper is formed within the circularly disposed food grip teeth.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1A is a top view of the self-aligning food pusher for use with a mandolin type slicer according to an implementation of the present principles;

FIG. 1B is a perspective view of the self-aligning food pusher according to an implementation of the present principles;

FIG. 2A is a bottom view of the self-aligning food pusher according to an implementation of the present principles;

FIG. 2B is a bottom perspective view of the self-aligning food pusher according to an implementation of the present principles;

FIG. 3A is a side view of the self-aligning food pusher showing the knob and corresponding shaft in their lower most position, in according to an implementation of the present principles;

FIG. 3B is a cross-sectional view of the self-aligning food pusher of FIG. 3A taken along lines A-A, according to an implementation of the present principles;

FIG. 4A is a side view of the self-aligning food pusher showing the knob and corresponding shaft in their upper most position, in according to an implementation of the present principles;

FIG. 4B is a cross-sectional view of the self-aligning food pusher of FIG. 4A taken along lines B-B, according to an implementation of the present principles;

FIG. 5 is an exploded view of the parts of the self-aligning food pusher according to an implementation of the present principles;

FIG. 6A is a side view of the self-aligning food pusher according to an implementation of the present principles.

FIG. 6B is a schematic view of the self-aligning food pusher engaging a mandolin slicer according to an implementation of the present principles;

FIG. 7 is a graphical representation of various mandolin slicer wall profiles with which the self-aligning food pusher is intended to be used; and

FIG. 8 is a graphical representation of the various angle ranges of the mandolin slicer wall profiles with which the self-aligning food pusher may be used.

### DETAILED DESCRIPTION

The present principles are directed to food slicing devices which use a food pushing device, such as, for example a mandolin slicer.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

For the purposes of promoting an understanding of the principles of the present disclosure, reference will now be made to the embodiments illustrated in the drawings, and specific language will be used to describe the same. It will nevertheless be understood that no limitation of the scope of the disclosure is intended. Any alterations and further modifications in the described devices, instruments, methods, and any further application of the principles of the disclosure as described herein are contemplated as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. The following discussion includes a description of a surgical rod measuring system and related methods in accordance with the principles of the present disclosure. Alternate embodiments are also disclosed. Reference will now be made in detail to the exemplary embodiments of the present disclosure, which are illustrated in the accompanying figures.

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “superior” and “inferior” are relative and used only in the context to the other, and are not necessarily “upper” and “lower”.

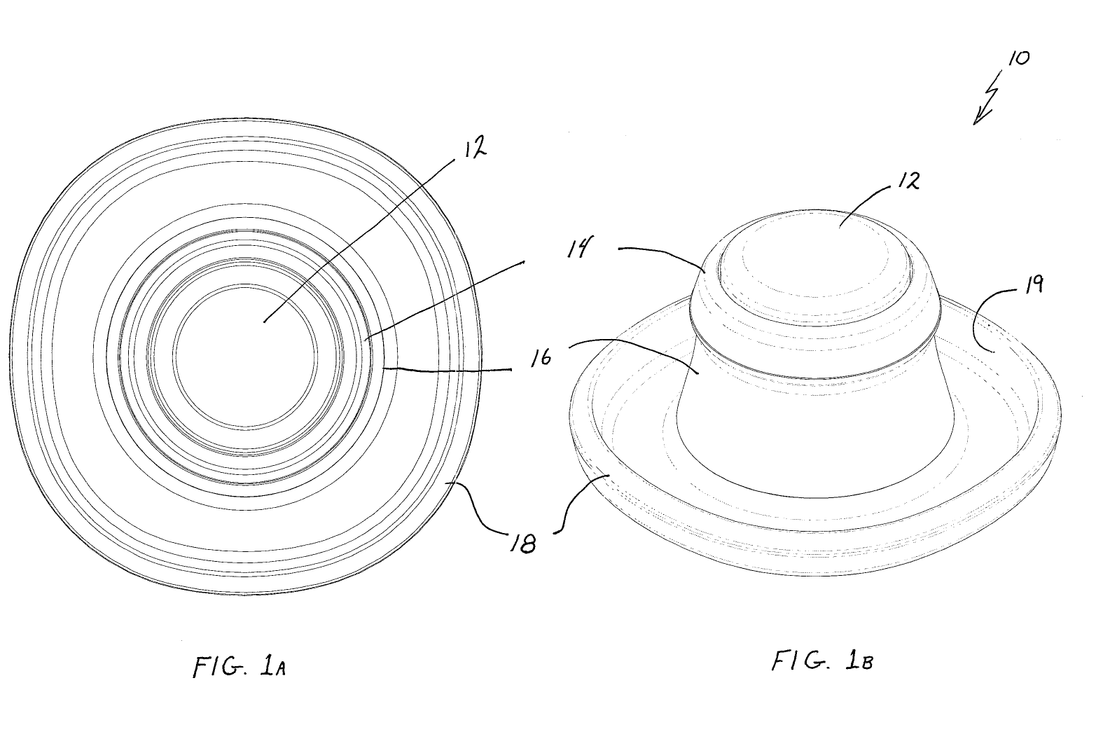

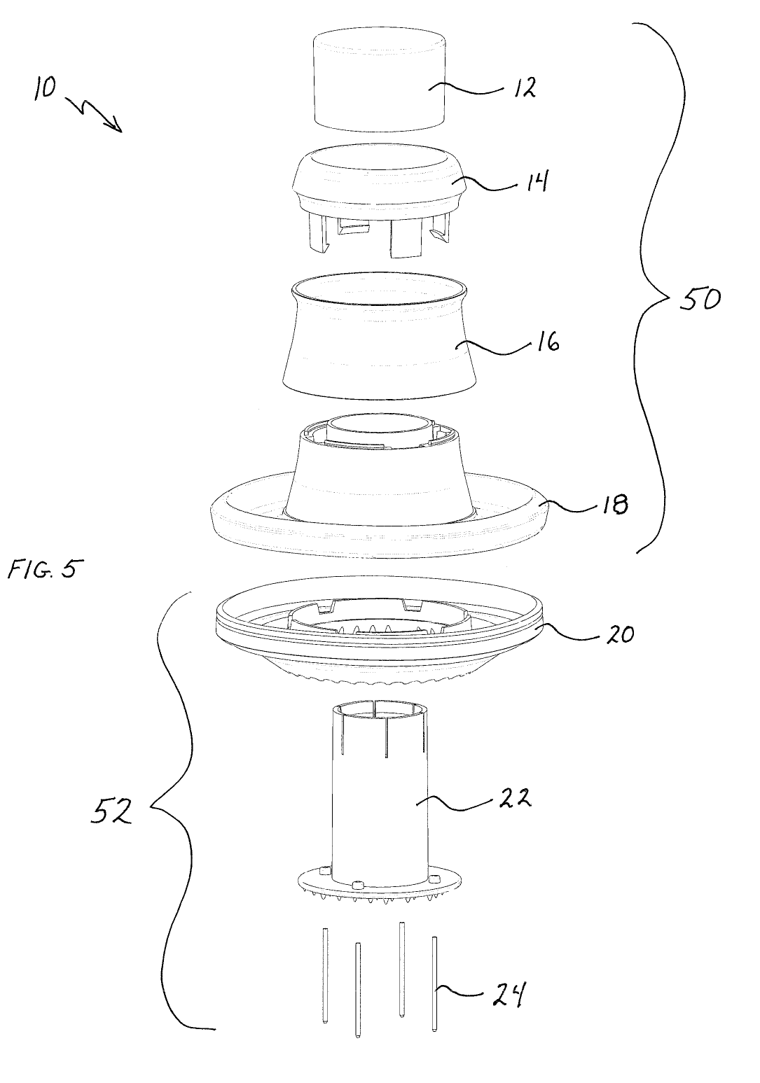

Referring to FIGS. 1, 2 and 5, there is shown the self-aligning food pushing device 10 according to an implementation of the present principles. In this implementation, the food pusher has an upper portion 50 (FIG. 5) which may include a knob 12, a body cap 14, a grip portion 16, a body 18, and a food grip 20. The grip portion 16 is an optional part and is not integral to the operation or assembly of the pusher 10. When grip portion 16 is implemented, it is preferred that it is made of rubber or some other material to increase the frictional engagement with the user's hand and/or make use of the same more comfortable and/or ergonomic. A lower portion 52 (FIG. 5) is generally made up of a plunger or shaft 22 that engages the knob 12 and includes a food engaging surface 23, having a plurality of spikes or points 26 molded therein. In addition, a plurality of fixed rods 24 also make up the lower portion 52.

The body 18 includes a circumferential lip 19 that creates an integrated finger guard which will prevent any accidental fingertip engagement with the slicing bed and/or the blade of the mandolin slicer during use of the same.

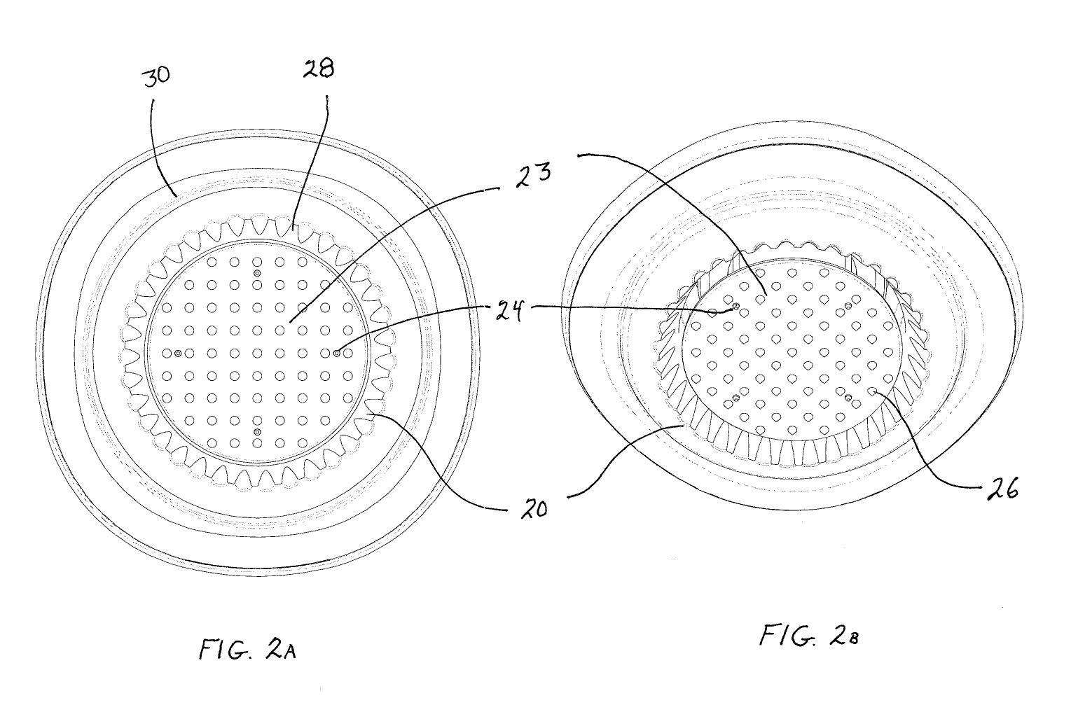

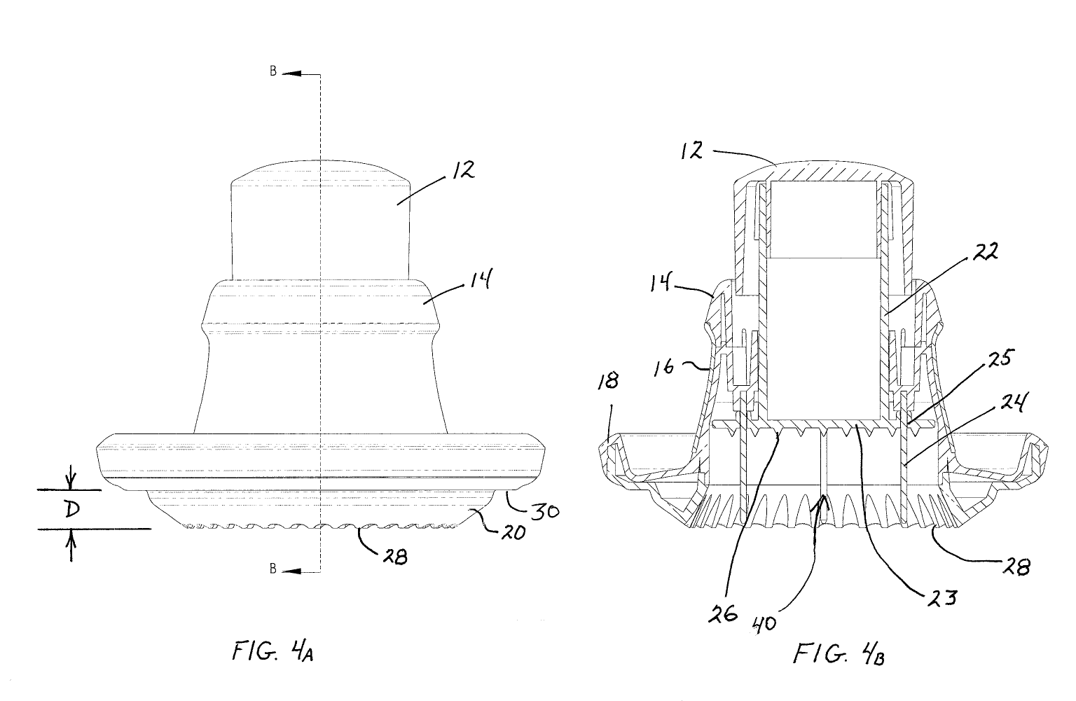

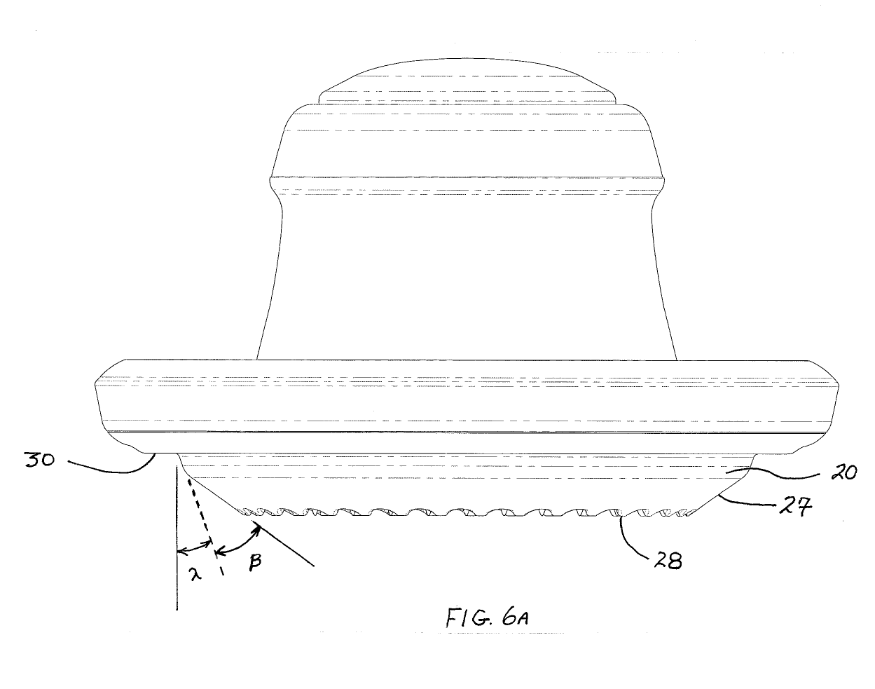

The underside of food grip 20 includes a circumferential or annular flat surface 30 configured to engage the side rails of the mandolin slicer in a self-aligning manner (described in further detail below). In operation, the flat surface 30 would engage the top surfaces of the side rails 64 (See FIG. 6B) when a food product being sliced has been completely sliced. As shown in FIGS. 2A and 2B, the food grip 20 includes a 360 degree grip/tooth feature 28, the inside of which forms the food hopper 40 (See FIG. 4B), which includes the food engaging surface 23 of the movable shaft 22, and non-movable rods 24.

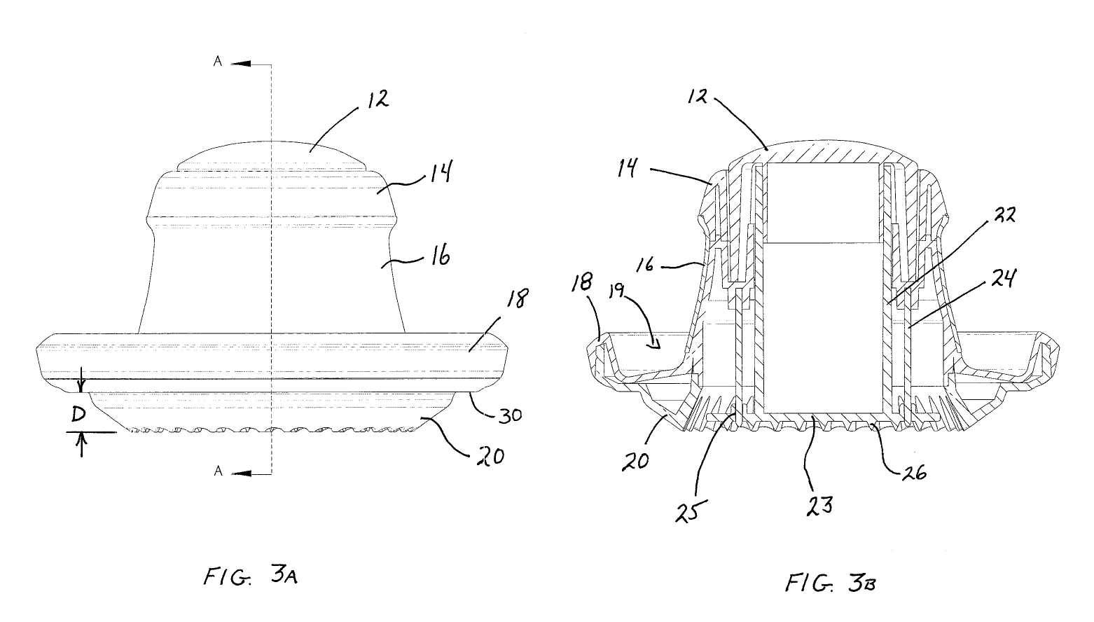

FIGS. 3A and 3B show the food pusher with the knob 12 and corresponding shaft 22 in the lower most position. This position is preferred for the slicing of tubular like food items (e.g., carrots, zucchini, eggplant, etc.). In this position, the food engaging points or spikes 26 of food engaging surface 23 are flush with the grip/teeth 26 circumferentially disposed there-around. In this manner, the tubular food item engages both the grip/teeth 28, the spikes 26 and fixed rods 24 which, in combination, prevents rotation of the same once so engaged. This gives the user a secure hold on the tubular food item while the longitudinally slice the same on the slicing bed of the mandolin slicer.

FIGS. 4A and 4B show the food pusher with the knob 12 and corresponding shaft 22 in an upper most position. This position is preferred for preparing to slice substantially spherical food items. In this position, a food hopper or chamber 40 is created by the withdrawal of the food engaging surface 23 up into the pusher. Yet, as noted above, the non-movable or fixed rods 24 remain extended with their tips being slightly recessed from the food grip teeth 28. The round or circular design of the food grip/teeth 28 allow the pusher to engage the spherical food item such that the food item is at least partially (or possibly fully) inside the food hopper 40 (and thereby secured therein via grip/teeth 28 and/or fix rods 24). The fixed rods 24 assist in the initial engagement of the food product, and once so engaged, the knob 12 is lowered to the point where the food engaging surface 23 engaged the food product.

During the slicing action, the knob 12 is depressed or continuously engaged such that the food engaging surface 23 urges or biases the food product downward, thus advancing the same toward the slicing bed of the slicer after each pass of the same. Repeated slicing action in this manner will ultimately result in the entire food item being sliced, and the knob 12 being full depressed as shown in FIGS. 1 and 3.

Referring to FIGS. 6A and 6B and in accordance with one preferred implementation, the mandolin slicer 60 has a slicing bed 62 recessed between opposing side walls or rails 64. The side rails 64 are angularly displaced with respect to the slicing bed 62 by a predetermined angle α. In this configuration, the circular food gripping portion 20 has an annular angled surface 27 which, in conjunction with the flat surface 30, provides the same with the ability to self-align between walls 64 and with the slicing bed 62. This self-alignment is implemented though the angled surface 27 of the food gripping portion 20. As shown in FIG. 6A, the angled surface 27 is at an angle equal to λ+β with respect to the flat surface 30. In one implementation this angle (λ+β) is in a range of 15°-65°, where λ=15°-25°, while β=0-40°. In a preferred embodiment, λ is approximately the same as the angle of the side walls 64 with respect to a vertical line. In other contemplated implementations, (λ+β) can be in a range of 1°-89° to accommodate specialized slicing systems (e.g., for specific food items) or to widen the range of food items that may be sliced with the disclosed slicing system.

During operation, as the food gripping portion 20 enters the slicing area created by walls 64, the angled surfaces 27 ensure the same will proceed methodically downward between the walls. As will be appreciated, the overall depth D of the food gripping portion 20 is configured to be just slightly less than the height H between the walls 64 and the slicing bed 62. In this manner, when flat surfaces 30 engage the top of walls 64, the food gripping portion 20 will sit just slightly above the bed 62 so as to slide freely and not interfere with the same or the blade contained therein.

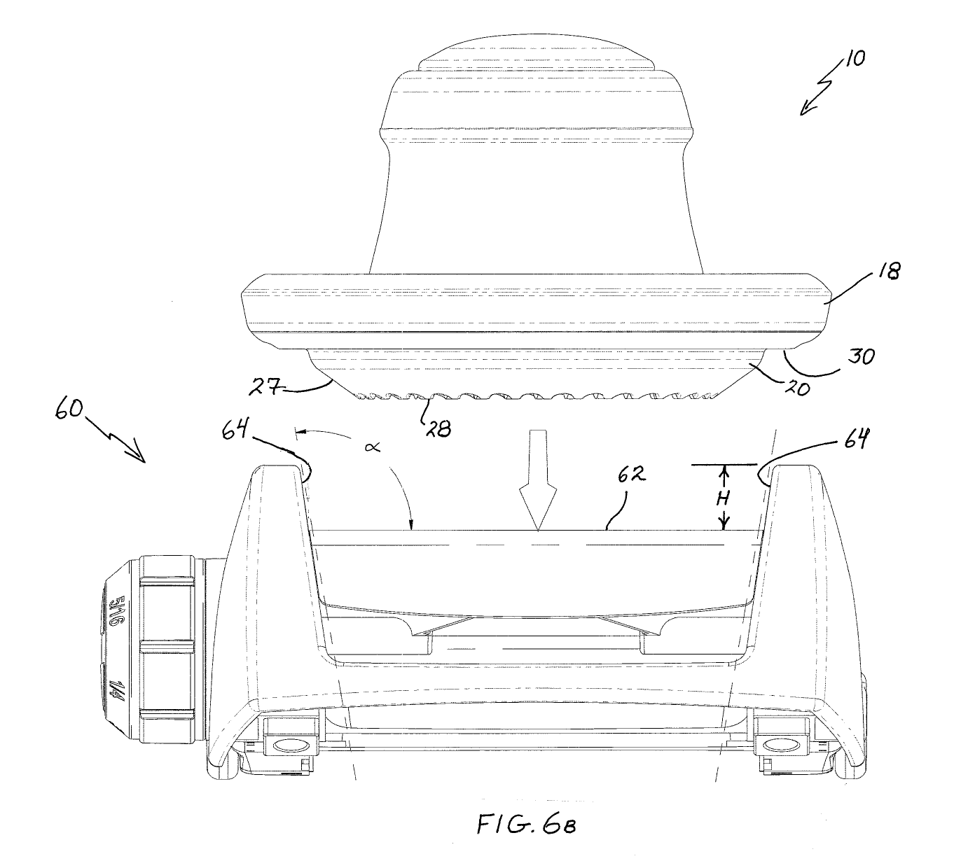

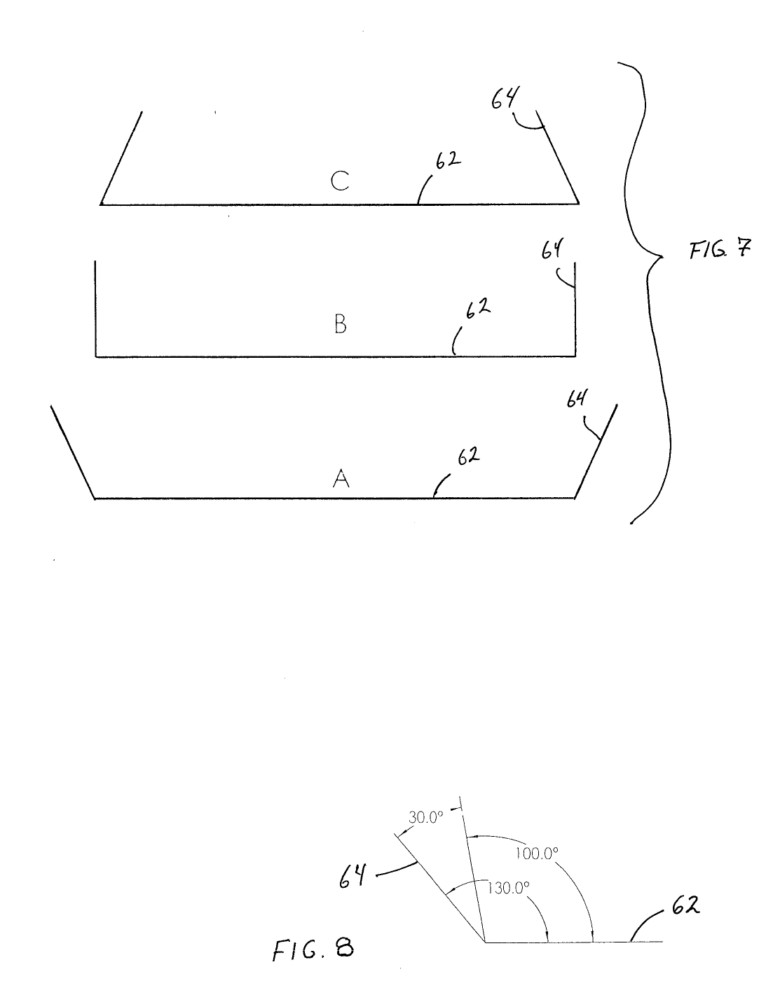

In accordance with one preferred implementation, the angle a is preferably in a range of 100°-130° (See FIG. 8), with 100 degrees being the preferred angle. However, as will be appreciated, this angle a can be increased or even decreased without departing from the scope of the disclosure. By way of example, FIGS. 7A-C show some examples of varied all configuration within which the food pusher of the present principles can also operate. FIG. 7A shows a design having an obtuse angle (and in this example, larger than the preferred 100 degrees), FIG. 7B shows a design having a right angle, while FIG. 7C shows the angle being an acute angle.

In accordance with one preferred implementation, all parts of the food pusher are made of plastic, with the exception of fixed rods 24 which are preferably metal. However, those of skill in the art will appreciated that different materials or even combinations of different materials may be used to fabricate the food pusher without departing from the spirit of the present disclosure. Examples of such materials can include plastic, stainless steel, casted, metals, aluminum, machined wood, ceramics, etc.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

What is claimed is:

1. A food slicing system comprising:
a mandolin slicer having two upwardly extending opposing side walls and a slicing bed positioned between the side walls; and
a food pusher having a circular food grip portion on an underside thereof and being configured to self-align within the walls of the slicer during use.

2. The food slicing system of claim 1, wherein the food pusher comprises:
an upper portion configured to be held by a user;
a lower food engaging portion, the lower food engaging portion comprising:
a food grip having a plurality of food grip teeth arranged on an underside thereof in a circular manner;
a shaft slidably engaged by the part of the upper portion and having a lower food engaging surface positioned within the circular plurality of food grip teeth;
a plurality of fixed rods positioned within the circular plurality of food grip teeth, said food engaging surface having a plurality of holes corresponding to the plurality of fixed rods such that said shaft slides freely over said fixed rods.

3. The food slicing system of claim 2, wherein the upper portion comprises:
a body having a lower end configured to be secured to the food grip;
a knob positioned at the top of the body and being connected to the slidable shaft, said knob enabling retraction and extension of the food engaging surface of the shaft;
wherein when the knob is retracted, a food hopper is formed within the circularly disposed food grip teeth.

4. The food slicing system of claim 2, wherein the food grip teeth further comprises an annular angled outer surface having an angle in a range of 1-89 degrees.

5. The food slicing system of claim 2, wherein the food engaging surface of the slidable shaft comprises a plurality of points configured to engage a food product, and in conjunction with said food grip teeth, thereby preventing any movement of the food item relative to the food pusher during use.

6. The food slicing system of claim 2, wherein said food grip further comprises a flat annular surface disposed around said plurality of food grip teeth, said flat annular surface being configured to engage a top surface of said side walls when a food product being sliced has been completely sliced.

7. The food slicing system of claim 4, wherein said side walls (64) of said mandolin slicer are angularly disposed with respect to said slicing bed such that said annular angled outer surface of said food grip teeth is received within the angularly disposed walls in a substantially mating configuration.

8. The food slicing system of claim 3, wherein said body further comprises a raised lip circumferentially disposed around said body, said lip forming a finger guard preventing any finger exposure to the slicing bed during use.

9. The food slicing system of claim 3, wherein said upper portion further comprises a hand grip extending upward from said body, said knob being positioned at a top of said hand grip, and said shaft being slidably engaged through said hand grip.

10. A food slicing system comprising:
a mandolin slicer having two upwardly extending opposing side walls and a slicing bed positioned between the side walls; and
a food pusher having a circular food grip portion on an underside thereof and being configured to self-align within the walls of the slicer during use, the food pusher comprising:
an upper portion configured to be held by a user and comprising:
a body having a lower end configured to be secured to the food grip;
a knob positioned at the top of the body and being connected to the slidable shaft, said knob enabling retraction and extension of the food engaging surface of the shaft;
wherein when the knob is retracted, a food hopper is formed within the circularly disposed food grip teeth; and
a lower food engaging portion, the lower food engaging portion comprising:
a food grip having a plurality of food grip teeth arranged on an underside thereof in a circular manner, food grip teeth further comprising an annular angled outer surface having an angle in a range of 1-89 degrees;
a shaft slidably engaged by the part of the upper portion and having a lower food engaging surface positioned within the circular plurality of food grip teeth;
wherein said side walls of the mandolin slicer are angularly disposed with respect to said slicing bed such that said annular angled outer surface of said food grip teeth is received within the angularly disposed walls in a substantially mating configuration.
